(19) United States
(12) Patent Application Publication
(10) Pub. No.: US 2026/0354297 A1
(43) Pub. Date: Nov. 12, 2026

(54) SYSTEMS AND METHODS FOR SEED MODIFICATION VIA PLASMA

(71) Applicant: Clean Crop Technologies, Inc., Holyoke, MA (US)

(72) Inventors: Shardul SREEKUMAR, Easthampton, MA (US); Sandon HESS, Norwalk, CT (US); Shaharyar YAQOOT, Springfield, NJ (US); Daniel CAVANAUGH, Arlington, VA (US); Daniel WHITE, Chesterfield, MA (US); Cody VILD, Amherst, MA (US)

(21) Appl. No.: 19/672,172

(22) Filed: May 8, 2026

Related U.S. Application Data
(60) Provisional application No. 63/803,356, filed on May 9, 2025.

(51) Int. Cl. A01C 1/06

(52) U.S. Cl. CPC A01C 1/06

(57) ABSTRACT

Embodiments described herein relate to systems and methods for treating seeds with plasma to reduce contamination, improve germination, and make seed growth more efficient. In some embodiments, a system may include: a reactor vessel configured to receive a plurality of seeds; a gas supply in fluid communication with the reactor vessel; an electrode assembly, the electrode assembly configured to receive a supply of current and the gas to produce a plasma; a thermal control device operably couplable to the reactor vessel; a conveyor configured to transport the plurality of seeds through the reactor vessel; and a power supply configured to power at least one of: the thermal control device, the electrode assembly, or the conveyor.

### CROSS-REFERENCE TO RELATED APPLICATIONS

This application claims priority to and the benefit of U.S. Provisional Patent Application No. 63/803,356, entitled “Systems and Methods for Seed Modification via Plasma,” filed May 9, 2025, the entire contents of which are hereby incorporated by reference.

### TECHNICAL FIELD

Embodiments described herein relate to systems and methods for treating seeds with plasma to reduce contamination, improve germination, and make seed growth more efficient.

### BACKGROUND

It is advantageous for seed growth to be uniform or predictable. Germinating seeds as quickly and reliably as possible can increase yields by increasing throughput in a growing cycle. However, seeds can become contaminated via human and plant-borne pathogens. Such pathogens can hinder radicle emergence and present as diseases in mature plants, delaying or stunting growth, killing them or making them unsuitable for commercial activity. They can also pose a risk to human health if consumed. Seeds that are grown in stressed conditions lack uniformity and yield. In order to prevent contaminations of seeds, the biochemistry of the seeds can be modified, altering the seed's biochemical pathways. Such treatments can also alter the surface morphology and surface chemistry of the seeds.

### SUMMARY

Embodiments described herein relate to systems and methods for treating seeds with plasma to reduce contamination, improve germination, and make seed growth more efficient. In some embodiments, a system includes: a reactor vessel configured to receive a plurality of seeds; a gas supply in fluid communication with the reactor vessel and configured to deliver a gas to the reactor vessel; an electrode assembly, the electrode assembly configured to receive a supply of current and the gas to produce a plasma; a conveyor configured to transport the plurality of seeds through the reactor vessel; and a power supply configured to power at least one of: the electrode assembly or the conveyor.

In some embodiments, a method includes: transferring a plurality of seeds to a reactor; transferring a gas to an electrode assembly, the electrode assembly including a ground electrode, a high-voltage electrode, and a dielectric, thereby forming a plasma; exposing the plurality of seeds to the plasma for a first time period; and applying heat to at least one of the plurality of seeds or the plasma for a second time period.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are, therefore, not to be considered limiting of its scope, the disclosure will be described with additional specificity and detail through use of the accompanying drawings.

FIG. 1 is a block diagram of a system for plasma treatment of seeds, according to an embodiment.

FIG. 2 is an illustration of a system for plasma treatment of seeds, according to an embodiment.

FIGS. 3A-3D are illustrations of a system for plasma treatment of seeds, according to an embodiment.

FIGS. 4A-4E are illustrations of a system for plasma treatment of seeds, according to an embodiment.

FIG. 5 is an illustration of an electrode assembly, according to an embodiment.

FIG. 6 is a flow diagram of a method of plasma treatment of seeds, according to an embodiment.

FIG. 7 shows example trends in rate of emergence of plasma treated seeds compared to untreated seeds.

Reference is made to the accompanying drawings throughout the following detailed descriptions. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. It will be readily understood that aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate to systems and methods for treating seeds with plasma to reduce contamination, improve germination, and make seed growth more efficient. In some embodiments, a system includes: a reactor vessel configured to receive a plurality of seeds; a gas supply in fluid communication with the reactor vessel and configured to deliver a gas to the reactor vessel; an electrode assembly, the electrode assembly configured to receive a supply of current and the gas to produce a plasma; a thermal control device operably couplable to the reactor vessel, the thermal control device configured to heat the electrode assembly to at least a temperature threshold; a conveyor configured to transport the plurality of seeds through the reactor vessel; and a power supply configured to power at least one of: the thermal control device, the electrode assembly or the conveyor.

In some embodiments, a method includes: transferring a plurality of seeds to a reactor; transferring a gas to an electrode assembly, the electrode assembly including a ground electrode, a high-voltage electrode, and a dielectric, thereby forming a plasma; exposing the plurality of seeds to the plasma for a first time period; and applying heat to at least one of the plurality of seeds or the plasma for a second time period.

Seeds can be vectors of contamination in the supply chain, as they can harbor plant pathogens, which negatively impact plant development, as well as food-borne pathogens, which pose a risk to human health if consumed. Therefore, decontamination of seeds is an important step in seed processing. Some technologies employed for seed treatment are aqueous in nature. This is energy intensive, as seed suppliers need to include a drying operation in the seed treatment process to prevent uncontrolled germination of the seeds. Even with appropriate drying post-aqueous treatment, in some instances, seeds are not able to withstand the treatment and the shelf-life and long-term storage of the seed is compromised. Another limitation of aqueous treatments is they have difficulty treating small seeds, like celery, since they become oversaturated and cannot dry effectively. Therefore, seed drying, associated with aqueous treatment processes, creates additional capital costs as well as labor and energy costs. Furthermore, aqueous treatments can also negatively impact the texture, taste, and appearance of the seeds and/or the plant product. Additionally, some processes that include the use of plasma have not been able to kill pathogens effectively enough while maintaining or improving germination. Plasma adoption has been limited to batch processes, which includes significant human handling to operate.

Embodiments described herein address these challenges by enabling effective seed treatment without inclusion of a drying step and by employing continuous or semi-continuous processes. Embodiments described herein can include modifying the transcriptome (e.g., ‘priming’ the seeds), altering the surface morphology, and/or changing the topology of the seeds by using plasma to expose the seeds to reactive gas species such as nitric oxide species, superoxides, and/or hydroxyl radicals.

Embodiments described herein relate to alteration of seeds' biochemical pathways via a ‘priming’ operation of the seeds. For example, some embodiments described herein can include modification of gene expression of seeds such that a subset of genes are differentially regulated after exposure to the plasma.

Embodiments described herein relate to modifying surface morphology by changing the surface chemistry of the seeds via exposure to reactive gas species (e.g., nitric oxide species, superoxides, and/or hydroxyl radicals). In some embodiments, the surface of the seeds can be chemically modified via conjugation of nitric oxide and hydroxyl species, such that the concentration of the hydroxyl species per unit of surface area increases. In some embodiments, a surface polarity of the seed may be modified due to exposure to nitric oxide species.

In some embodiments, exposure to nitric oxide species can also modify the seed topology by changing the porosity (e.g., weakening the seed coat) and/or wettability of the seed, thereby improving growth and/or encouraging radicle emergence. Embodiments described herein can include subjecting seeds to surface etching. Surface treatments of seeds can affect surface roughness of the seeds, thereby decreasing the contact angle and improving wettability of the seed.

Without being bound by any particular theory, it is believed that the combination of ‘priming’ (e.g., modification of the transcriptome) and surface modifications (e.g., surface morphology and/or topology changes) results in higher plant vigor and increased rates of germination. Furthermore, it is believed that the combination of ‘priming’ and surface modifications enables better control of germination and the ability to grow seedlings in stressful environments. Seeds subjected to plasma exposure can have improved performance because ablation of the seed surface can physically remove microbes and reduce the microbial load. Plasma, and the reactive gases plasma creates, can directly kill deleterious pathogens. Heat can also kill such pathogens; therefore, embodiments described herein may include exposing seeds to heat to improve decontamination of the seeds. Seed surface wetting properties from both seed topology and surface polarity can be altered such that there is preferential regrowth of remaining microbial populations. Enablement of the growth of probiotic species can generate higher yields with potentially fewer crop production inputs. Metabolomic changes, from changes to the transcriptome, may ‘prime’ the seed to be more resistant to endophytic attack from pathogens, or other pathogens. Because of altered wetting properties and transcriptional changes, it is believed that seeds can have increased yield, improved vigor, and uniform growth rates from seedlings, making plant management simpler.

Seeds treated with processes described herein have improved radicle emergence and length. The total amount of seeds has a higher percentage of radicle emergence post treatment, and a higher percentage of seeds have a longer length of radicle at a given point in time. This is equated with increased plant vigor because it is believed faster emergence enables the seeds to be more resilient to abiotic stressors such as heat and/or drought.

Embodiments described herein can employ direct cold plasma treatment to seed. Some embodiments described herein use automated and fully integrated control of plasma-implementing systems. Existing systems do not employ direct exposure of cold plasma to the seeds.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “example” as used herein to describe various embodiments or arrangements is intended to indicate that such embodiments or arrangements are possible examples, representations, and/or illustrations of possible embodiments or arrangements (and such term is not intended to connote that such embodiments or arrangements are necessarily crucial, extraordinary, or superlative examples).

As used herein, the terms “substantially’ and similar terms are intended to have a broad meaning in harmony with the common and accepted usage by those of ordinary skill in the art to which the subject matter of this disclosure pertains. For example, the term “substantially flat” would mean that there may be de minimis amount of surface variations or undulations present due to manufacturing variations present on an otherwise flat surface. It should be understood by those of skill in the art who review this disclosure that these terms are intended to allow a description of certain features described and claimed without restricting the scope of these features to the precise arrangements and/or numerical ranges provided. Accordingly, these terms should be interpreted as indicating that insubstantial or inconsequential modifications or alterations of the subject matter described and claimed are considered to be within the scope of the inventions as recited in the appended claims.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “substantially” when used in connection with a numeric parameter is intended to convey that the numeric parameter may vary by about plus or minus about 5%. For example, the term “substantially uniform pressure” implies that the pressure applied may vary ±5% across the entire surface or volume being considered.

The terms “coupled,” and the like as used herein mean the joining of two members directly or indirectly to one another. Such joining may be stationary (e.g., permanent) or moveable (e.g., removable, or releasable). Such joining may be achieved with the two members, or the two members and any additional intermediate members being integrally formed as a single unitary body with one another or with the two members or the two members and any additional intermediate members being attached to one another.

As used herein, the term “set” and “plurality” can refer to multiple features or a singular feature with multiple parts. For example, when referring to a set of seeds, the set of seeds can be considered as one seed with multiple portions, or the set of seeds can be considered as multiple, distinct seeds. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the terms “about” or “approximately” when preceding a numerical value indicates the value plus or minus a range of 10%. For example, about 0.5 would include 0.45 and 0.55, about 10 would include 9 to 11, about 1,000 would include 900 to 1,100. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

As used herein, the term “seed” can refer to a unit of reproduction of a flower plant that is capable of developing into another such plant. The term “seed” may refer to any plant material that can be sown, which may include, for example, nuts, legumes, grains, husks, and/or tubers.

All definitions, as defined and used herein, should be understood to control over dictionary definitions, definitions in documents incorporated by reference, and/or ordinary meanings of the defined terms.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

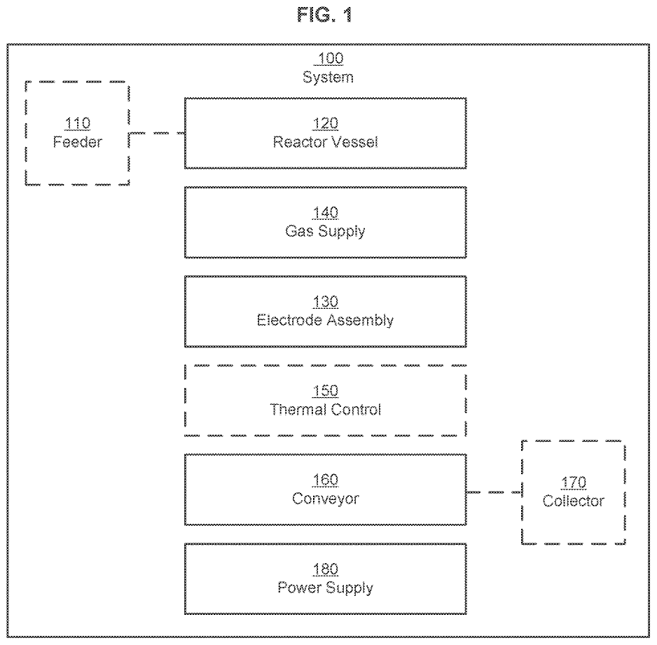

FIG. 1 is a block diagram of a system 100 including a reactor 120 configured to deliver plasma treatment to seeds, according to an embodiment. In some embodiments, the reactor 120 may be configured to deliver direct cold plasma treatment to a plurality of seeds. In some embodiments, control of the system 100 may be automated and/or fully integrated into the system 100. For example, the system 100 may be configured to directly expose the plurality of seeds to the cold plasma, and one or more characteristics of the plasma and/or an environment inside the reactor 120 may be controlled by the system 100. The reactor 120 may include one or more electrodes 130, a gas control assembly 140, a thermal control assembly 150, and a conveyor 160. The system 100 may include a feeder 110 configured to transport the seeds to the reactor 120, and a collector 170 configured to collect the seeds after the seeds undergo treatment. In some embodiments, the feeder 110 may include a hopper (e.g., container, funnel, channel, conduit, etc.). In some embodiments, the hopper may include a funnel-like structure configured to receive a first quantity of seeds and to dispense a second quantity of seeds into the reactor 120. In some embodiments, the feeder 110 may further comprise a chute connected to the hopper, the chute configured to control movement of the seeds (e.g., control a speed and/or an arrangement of the seeds) as the seeds move toward the reactor 120. In some embodiments, the feeder 110 may control a rate at which the seeds are deposited in the reactor 120 (e.g., a feeder rate). The feeder 110 can deposit seeds into the reactor 120 at a rate of 2 metric tons per hour, or greater.

In some embodiments, the feeder 110 and/or the conveyor 160 may be configured to dispense and/or convey the seeds such that, for example, the seeds can form thin sheet(s) (e.g., a monolayer, bilayer, tri-layer), be fluidized, agitated, or otherwise conveyed. As discussed in further detail herein, in some embodiments, at least a portion of the conveyor 160 may be disposed within the reactor 120. In such embodiments, the conveyor may be operable to expose substantially all seeds to gas reactive species evolved by the electrodes 130. In some embodiments, the feeder 110 may be configured to dispense the seeds such that a seed bed has a predetermined thickness or height. The feeder 110 may be configured to dispense seeds (e.g., on a surface of an electrode, on a surface of a conveyer, to the conveyor 160, etc.) at a predetermined rate (e.g., weight per minute, volume per minute, seeds per minute, etc.) and/or a predetermined density (e.g., seeds and/or weight per surface area and/or volume).

In some embodiments, one or more portions of the feeder 110 may be configured to vibrate to move the seeds toward the reactor 120. For example, the chute may be coupled to the conveyor 160 and configured to vibrate or shake such that the seeds form a thin sheet and/or fluidized bed as the seeds move toward the reactor 120.

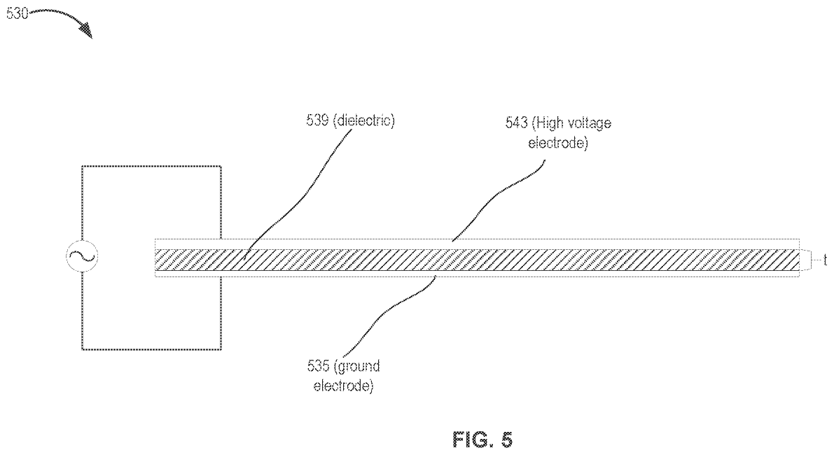

In some embodiments, the reactor 120 may include a vessel or container including the one or more electrodes 130 disposed therein. In some embodiments, the reactor 120 may include a plurality of electrodes 130. In some embodiments, the electrodes 130 may be arranged in an electrode assembly including a first electrode, a second electrode, and a dielectric plate disposed therebetween. In some embodiments, the first electrode may be configured as a high-voltage electrode and the second electrode may be configured as a ground electrode. In some embodiments, the high-voltage electrode includes a first surface (e.g., a top surface) and a second surface (e.g., a bottom surface), and the seeds may be disposed on or move across the first surface (e.g., the top surface) of the high-voltage electrode(s) 130. Voltage may be applied across the electrodes 130 such that plasma is generated across the first surface of the high-voltage electrode(s) 130 and/or between the high-voltage and ground electrodes 130. In some embodiments, the plurality of electrodes 130 may be arranged such that the high-voltage electrodes 130 form a path between the feeder 110 and the collector 170, and the seeds may move across the first surface of the high-voltage electrodes 130 into the collector 170. In some embodiments, the electrodes 130 may be arranged linearly to form the path between the feeder 110 and the collector 170. In some embodiments, the electrodes may be arranged in any suitable shape such as, for example, a square, rectangle, circle, oval, zig-zag, serpentine path, etc. In some embodiments, the active surface of each electrode 130 may have any suitable shape. For example, the active surface of each electrode 130 may include a square, rectangle, pentagon, hexagon, circle, oval, and/or any other suitable shapes. In some embodiments, the active surface of the electrode(s) 130 includes a hexagon. In some embodiments, each electrode 130 includes a hexagon shape such that the plurality of electrodes 130 arranged together form a hexagonal pattern (i.e., a honeycomb pattern). In some embodiments, the electrode(s) 130 can be placed in a coplanar configuration, for example, so that seeds can pass through passage with an electrode above and an electrode below. The electrodes 130 are described in further detail with respect to FIG. 5.

In some embodiments, the conveyor 160 may include a belt(s), plates, trough, vibratory surface, etc. at least partially disposed in the reactor 120. The conveyor 160 may be configured to transport the seeds from the feeder 110 to the reactor 120 through the reactor 120 and/or toward the collector 170. In some embodiments, the conveyor 160 may be operatively coupled to the electrode(s) 130 and configured to move the electrode(s) 130 as the seeds are disposed thereon such that the seeds are moved toward the collector 170. In some embodiments, the conveyor 160 may include a vibratory mechanism or a vibration device configured to vibrate or shake the seeds to move the seeds toward the collector 170. For example, the electrode(s) 130 may be affixed to a bed or a base that shakes or vibrates such that the seeds move across the electrode(s) 130 from the feeder 110 toward the collector 170. In some embodiments, the vibratory mechanism may be configured to shake the seeds such that the seeds form the thin sheet arrangement (e.g., the monolayer). In some embodiments, the conveyor 160 may be configured to transport the seeds such that the seeds are substantially uniformly distributed across the electrode(s) 130. In some embodiments, the shaking may also provide random motion to each seed to increase the surface exposure of each seed to plasma generated by the electrode(s) 130.

In some embodiments, the conveyor 160 may include one or more conveyor belts to move the seeds through the reactor 120. In some embodiments, the conveyor 160 (e.g., the one or more conveyer belts) may include an air permeable material (e.g., a mesh or the like). For example, the electrodes may be disposed under a conveyer belt, and the seeds may be disposed on top of the conveyer belt, and the conveyer belt may include a material that is permeable to gas such that the reactive gas species generated by the plasma may move through the conveyer belt to the seeds disposed thereon. In some embodiments, the conveyor 160 may include a material (e.g., a gas permeable material) to promote transfer of plasma and/or thermal energy to the seed. In some embodiments, the seeds may be moved through the chamber due to a gravitational force on the seeds. For example, the seeds may start at a top portion of the reactor 120 and fall or roll downward through the reactor 120 such that the seeds are exposed to the plasma and/or reactive gas species as they move downward through the reactor 120. Alternatively or additionally, the electrodes 130 may be configured to move relative to the seeds. For example, the seeds may remain stationary during treatment, and one or more electrodes 130 may be moved above and/or below a portion of the seeds and activated to treat the portion of the seeds. In some embodiments, the electrodes 130 may be configured to treat the portion of the seeds and then move to a subsequent portion of the seeds and treat the subsequent portion (e.g., a carousel configuration).

Alternatively or additionally, the conveyor 160 may include a distribution mechanism (e.g., a gantry) including a movable member configured to distribute a predetermined quantity of seeds into one or more predefined areas in a treatment zone in the reactor 120. In some embodiments, the distribution mechanism may be configured to dispose the seeds onto each electrode 130 such that the seeds are arranged in one or more layers such that the seeds collectively have a predetermined thickness or depth (e.g., thin sheet arrangement) on the electrode 130. In such embodiments, the reactor 120 may include a first set of electrodes and a second set of electrodes. The seeds may be disposed on the first set of electrodes, and the second set of electrodes may be configured to move in a first direction toward the first set of electrodes such that the seeds are disposed therebetween. In some embodiments the seeds may be disposed between a top surface of the first set of electrodes and a bottom surface of the second set of electrodes. In some embodiments, a distance between the top surface of the first set of electrodes and the bottom surface of the second set of electrodes can be substantially equivalent to the thickness or depth of the seeds (e.g., the thickness of the one or more layers of seeds from the surface of the electrode on which they are disposed). Similarly stated, in some embodiments, seeds can substantially fill the space between the top surface of the first set of electrodes and the bottom surface of the second set of electrodes. For example, the top surface of the first set of electrodes and the bottom surface of the second set of electrodes may each contact a portion of the seeds. In other embodiments, the distance between the top surface of the first set of electrodes and the bottom surface of the second set of electrodes may be larger than the thickness of the seeds on the electrode 130. In some embodiments, the spacing between the first set of electrodes and the second set of electrodes can be adjustable. The first set of electrodes and the second set of electrodes, collectively, may be configured to create two fields of plasma to ensure full coverage of the seeds disposed therebetween. In some embodiments, the distance between the first set of electrodes and the second set of electrodes may correspond or may be adjustable to correspond to a volume or thickness of the plasma field generated by each set of electrodes 130. For example, the first set of electrodes and the second set of electrodes may be spaced such that the plasma field fills the entire space therebetween. For example, the distance may be in a range of about 0.5 mm to about 10 inches, inclusive of all ranges and subranges therebetween.

In some embodiments, the electrode(s) 130 on which the seeds are disposed may be coupled to an actuator (e.g., the electrode(s) may be disposed on a pneumatic lever) to move (e.g., push, rotate, tilt) the electrode(s) 130 in a second direction such that the seeds slide off into the collector 170 after plasma has been applied. The conveyor 160 may be configured such that the system 100 has faster throughput (e.g., volume of seed treated per unit of time) than existing methods and systems for seed treatment. In some embodiments, a combination of a vibratory mechanism and a distribution mechanism can be used to transport the seeds between the feeder 110 and the collector 170 (e.g., across the electrode(s) 130).

In some embodiments, the system 100 may be configured to deliver the plasma treatment with few interaction points from a user. For example, the system 100 may be configured to move the plurality of seeds through the system 100 between the feeder 110 and the collector 170 without manual intervention (e.g., automatically). Therefore, the system 100 may be configured such that the only touch points from the user are inputting the seeds into the feeder 110 and removing seeds from the collector 170.

In some embodiments, each electrode 130 may be configured to generate plasma on or adjacent to a surface configured to contact the seeds. For example, the electrode(s) 130 may be configured to generate plasma on or above the first surface (the top surface) on which the seeds are disposed. In embodiments in which two sets of electrodes are used, the first set of electrodes may be configured to generate plasma on or above the first surface, and the second set of electrodes may be configured to generate plasma on or below the second surface (the bottom surface). In some embodiments, current applied through the electrode(s) 130 (e.g., the applied current) may be pulsed such that plasma generation, and therefore plasma exposure of the seeds, is pulsed. In some embodiments, one or more characteristics of the plasma field (e.g., a temperature of the plasma, a composition of the plasma, a volume of the plasma, etc.) may be controlled by controlling one or more parameters of the system 100. In some embodiments, the parameters may include at least one of a voltage across the electrode(s) 130, a pulse frequency, a duty cycle, and a pulse width.

The plasma field may be controlled by controlling the voltage across the electrode(s) 130. In some embodiments, the voltage across the electrode(s) 130 is between about 1 kV to about 30 kV, inclusive of all ranges and subranges therebetween. In some embodiments, there is a voltage threshold at which the electrode(s) 130 begin to form plasma arcs. In some embodiments, the voltage across the electrodes 130 is configured to be below the voltage threshold. In some embodiments, the voltage across the electrodes 130 is between 1.7 kV to about 5 kV, inclusive of all ranges and subranges therebetween. In some embodiments, the voltage across the electrode(s) 130 is about 2 kV to about 4 kV. In some embodiments, the voltage across the electrode(s) 130 is about 3 kV.

In some embodiments, the pulse frequency (e.g., a pulse rate) of the applied current may be adjusted to control one or more characteristics of the plasma field and/or to control an exposure time of the plurality of seeds to the plasma field. Exposure to plasma may cause etching in a surface of the seed. In some embodiments, a lower pulse frequency may cause a higher etch rate resulting in deeper etches on the surface of each seed. Whereas a higher pulse frequency (e.g., megahertz range) results in shallower but more uniform etching (e.g., a depth of the etchings may be more uniform). In some embodiments, the pulse frequency may be in a range of about 1 kHz to about 30 kHz, inclusive of all ranges and subranges therebetween. In some embodiments, the pulse frequency may be in a range of about 10 kHz to about 20 kHz, inclusive of all ranges and subranges therebetween. In some embodiments, a low voltage (e.g., about 3 kV) may be used with a high frequency (e.g., about 20 kHz) to achieve the desired plasma field.

In some embodiments the pulse width of the applied current may be adjusted (e.g., pulse width modulation) to control one or more characteristics of the plasma field and/or the exposure time of the seed to the plasma. In some embodiments, the pulse width may be between about 25% to about 100%, inclusive of all ranges and subranges therebetween. In some embodiments, when the pulse width is below 25%, a rate of ozone generation may begin to decrease. In some embodiments, a lower limit of the pulse width modulation may be determined based on the rate of ozone generation. The pulse width may control a level of heat generated at the surface of the electrodes 130. In some embodiments, determination of the pulse width may be based on a desired level of heat generated at the surface of the electrodes 130. Similarly stated, the pulse width can be selected to produce a target temperature at the surface of the electrodes 130.

In some embodiments, the electrodes can be configured to produce a power density of about 5 kW/m² to about 20 kW/m², inclusive of all ranges and subranges therebetween. Similarly stated, an electrode having an area of about 100 cm² can be configured to produce about 50-200 W. In some embodiments, a temperature of the plasma may be in a range of about 0 °C to about 150 °C, inclusive of all ranges and subranges therebetween. In some embodiments, the temperature of the plasma may be in a range of about 0.5 electron volts (eV) to about 5 eV, inclusive of all ranges and subranges therebetween. When activated, the electrodes 130 may generate a surface discharge of plasma having a thickness in a range of about 0.1 millimeter (mm) to about 3 mm, inclusive of all ranges and subranges therebetween.

In some embodiments, the reactor 120 may deliver a combination of a plasma field with predetermined characteristics and one or more additional seed decontamination treatments. In some embodiments, the reactor 120 may deliver a combination of a plasma field with predetermined characteristics and heat in a predetermined temperature range resulting in a change in a composition of the seeds during or after treatment. Exposing the seeds to heat and plasma together may be more effective than exposing the seeds to only one of the treatments. In some embodiments, a maximum temperature of heat delivered may be determined at least in part by a tolerance of the type of seed to be treated. A minimum temperature of the heat delivered may be determined at least in part by target pathogens to eliminate (e.g., a use case). In some embodiments, the predetermined range of temperature of heat may be used to generate a plasma field that weakens pathogens and causes the pathogens to be more susceptible to the reactive gas species generated by the plasma. In some embodiments, the maximum temperature of the heat applied to the seeds may depend at least in part on an exposure time of the seeds to the heat. For example, if heat is applied for a lower amount of time, the maximum temperature the seeds may endure is higher than if heat is applied for a greater amount of time. In some embodiments, a dryness/water content of the seed can impact a maximum temperature the seed can tolerate. In some embodiments, a water content of the seed can impact a maximum temperature the seed can tolerate.

In some embodiments, the thermal control assembly 150 may include a heater operably coupled to the reactor 120. In some embodiments, heat may be generated by the electrode(s) 130 when current and/or voltage is delivered to the electrode(s) 130. In some embodiments, heat can be controlled by pulsing voltage and/or current through the electrodes 130. In some embodiments, the temperature at the surface of each electrode 130 may be in a range of about 25 °C (about 80 °F) to about 105 °C (about 220 °F), inclusive of all ranges and subranges therebetween. In some embodiments, the temperature at the surface of each electrode 130 may be about 38 °C (about 100 °F). Additionally or alternatively, a temperature of the air inside the reactor 120 may be controlled. For example, the heater may be configured heat the air inside the reactor 120 (e.g., air near the seeds) such that the seeds are exposed to the heat via the air/plasma. Alternatively and/or additionally to a heater configured to heat the air in the reactor 120, the system 100 may include a chiller configured to cool the air in the reactor 120, for example, in embodiments and/or instances in which the electrodes 130 produce more heat than is desired.

In some embodiments, the electrode(s) 130 may be coupled to a cooling system to control the temperature at the surface of the electrode(s) 130. In some embodiments, the cooling system may include a structure placed in contact with the electrode(s) 130 such that heat from the electrode(s) is dissipated to the structure. In some embodiments, the structure may include metal to dissipate the heat. In some embodiments, the metal of the structure may include aluminum, silver, copper, brass, or a suitable combination thereof. In some embodiments, the cooling system may further include a coolant (e.g., a liquid coolant) coupled to the structure such that heat is transferred to the coolant and removed from the reactor 120 as coolant moves out of the reactor 120. In some embodiments, one or more tubes or channels through which coolant may move may be place in contact with the structure. In some embodiments, the structure may include a metal block, slab, plate, or any other suitable structure. In some embodiments, a metal plate may be disposed underneath the electrodes 130 and configured to absorb heat from the electrode(s) 130 and pass the heat to the coolant.

In some embodiments, the plasma may generate one or more reactive gas species (RGS) in the reactor 120. More specifically, the plasma may generate one or more reactive gas species near a surface of the electrodes 130 on which the seeds are disposed. In some embodiments, the one or more reactive gas species may be configured to interact with and/or decontaminate at least a portion of each seed. In some embodiments, the reactive gas species may include at least one of ozone, superoxides, hydroxyl radicals, nitrates, nitrites, and/or peroxides (e.g., hydrogen peroxide). Ozone may be the primary active agent generated by the plasma and may be a catalyst for forming other reactive gas species.

In some embodiments, an intake gas (e.g., gas received by the reactor 120 before or during treatment of the seeds) may be controlled by the system 100 via the gas control assembly 140. In some embodiments, the gas control assembly 140 may include a gas supply fluidically coupled to the reactor 120 and configured to deliver gas to the reactor 120. The gas supply can include one or more bottles of high purity gases and/or gas mixtures, a (e.g., hard plumbed) process gas source, an inlet to atmospheric air, an air purifier and/or air scrubber, a humidifier and/or dehumidifier, and/or any other suitable gas source. In some embodiments, the reactor 120 may be configured to deliver a plasma field with predetermined characteristics and to control one or more characteristics of the intake gas. In some embodiments, at least one of the following characteristics of the intake gas can be controlled to impact the seed treatment process: a relative humidity level, a temperature, a pressure, a concentration of one or more chemicals, a concentration of one or more gas species, etc.

In some embodiments, the reactor 120 may include conditioned air therein to control the seed treatment process. In some embodiments, atmospheric air composition can be used, and the humidity and/or temperature of the air may be controlled. Higher humidity (e.g., 70-80% relative humidity) of the air can aid in the decontamination process; however, high humidity may damage the electrodes 130 and/or may impede plasma ignition within the critical voltage ranges used. Therefore, the humidity in the reactor 120 may depend on a type of electrode included in the system 100. In some embodiments, the relative humidity may be between 70-80% to improve decontamination. In some embodiments, the relative humidity may be at or below about 30%.

In some embodiments, the composition of the intake gas (e.g., the concentration of one or more gases in the air inside the reactor 120 during decontamination) may be controlled to obtain the optimal plasma field and/or optimal reaction kinetics. In some embodiments, one or more additive gases (e.g., noble gases) may be added to the intake gas to control the plasma field generated and the performance of the plasma. In some embodiments, concentrations of gases including, but not limited to: ozone (O₃), oxygen (O₂), carbon dioxide (CO₂), nitrogen (N₂), noble gases (e.g., helium (He), neon (Ne), argon (Ar), krypton (Kr), xenon (Xe)) may be controlled to improve effectiveness of the plasma field generated for decontaminating) seeds. Other chemicals may be added in the gas phase (e.g., in water droplets) including, but not limited to, hydrogen peroxide (H₂O₂), nitric acid (HNO₃), peracetic acid (C₂H₄O₃), and/or acetic acid (CH₃COOH) to alter concentrations of reactive gas species to a more optimal state. In some embodiments, an initial concentration of the one or more gases or chemicals may be controlled. In some embodiments, a rate of exchange of the one or more gases or chemicals (e.g., ozone and nitrous oxide) may be controlled to maintain optimal plasma conditions over time. A mechanism to increase and/or decrease the relative concentration of the one or more gases or chemicals may be used. For example, the reactor 120 may include an ozone destructor to reduce the relative concentration of ozone in the air inside the reactor 120.

Higher concentration of water in the air (e.g., higher relative humidity) may be beneficial to the decontamination process because water is converted to hydroxyl radicals when exposed to plasma. Noble gases can change the breakdown voltage of air, meaning the air may be ionized at lower voltages. In other words, the introduction of noble gases may increase the reduced electric field (at a given temperature and pressure) and improve overall conductivity and stability of the plasma generated. Therefore, addition of Noble gases may enable a plasma field with better properties for decontamination. Ozone and nitric acid enhance decontamination of seeds by the plasma; however, these compounds may damage the electrode(s) 130. Therefore, the concentration level of these compounds may be determined based on properties of the electrode(s) 130 of the system 100. Additionally, ultraviolet (UV) can also be used to alter the chemical kinetics of the reactive gas species generated by the plasma field. In some embodiments, one or more parameters for plasma generation (e.g., high voltage) may be controlled to create ionic winds which are turbulent enough to move seeds out of the reactor 120.

In some embodiments, a flow rate of the air in the reactor 120 can be controlled. In some embodiments, the flow rate can be below an upper threshold such that ozone concentration does not build up and begin to degrade the electrodes 130 (e.g., via ozone poisoning), but above a lower threshold such that generation of the reactive gas species is large enough to successfully decontaminate the seeds. In some embodiments, the flow rate may be in a range of about 5 lpm to about 1000 lpm, inclusive of all ranges and subranges therebetween.

In some embodiments, the system 100 may include one or more controllers (not shown) that controls functioning of the electrodes 130, the gas control assembly 140, the thermal control assembly 150, and/or the conveyor 160. In some embodiments, the controller(s) may include software and/or hardware for controlling the system 100. In some embodiments, the controller(s) may run or execute code (e.g., one or more processes, modules, functions, etc.) to control the system 100. In some embodiments, the controller(s) may control power distribution from a power supply to the components of the system 100. In some embodiments, the controller(s) may control delivery of plasma through the electrode(s). For example, the controller(s) may control current and/or voltage magnitude, frequency, pulse-width, and/or duty cycle applied to the electrode(s) 130. In some embodiments, the controller(s) may be configured to control movement of the electrodes 130 via the conveyor 160. In some embodiments, the controller(s) may be configured to receive input from the user, and to control the system 100 according to the input. In some embodiments, the controller(s) may be configured to communicate with other controller(s) and/or one or more processors (e.g., onboard the system 100 and/or external to the system 100). In some embodiments, the one or more processors may be configured to determine one or more parameters of the reactor 120 based on a seed type and/or use-case. In some embodiments, the user may initially input one or more parameters for plasma treatment, and the system 100 may be configured to automatically deliver the plasma treatment based on the input. In some embodiments, the system 100 may be configured such that the user may input a species of seed, and the system 100 may be configured to deliver plasma treatment based on the input.

The residence time of the seeds is a total amount of time the seeds are in the reactor 120. In some embodiments, the seeds may have a residence time in a range of about 10 seconds to about 1 hour, inclusive of all ranges and subranges therebetween.

The exposure time of the seeds is a total amount of time the seeds are exposed to a decontamination treatment (e.g., plasma treatment and/or heat treatment) in the reactor 120. In some embodiments, the seeds may have an exposure time in a range of about 5 seconds to about 1 hour. It has been observed that in some instances decontamination initially increases with exposure duration but begins to drop off beyond about 15 seconds. Accordingly, in some instances, exposure times may be limited to about 30 seconds to 1 minute, as additional exposure has minimal additional decontamination effect. In some embodiments, an exposure time and/or a residence time may be determined based on target pathogens to eliminate and/or a type of seed to be treated. In some embodiments, an intensity of plasma and/or heat applied may depend at least in part on the exposure time of the seeds. For example, if plasma and/or heat is applied for a lower amount of time, the maximum intensity of plasma and/or heat the seeds may endure may be higher. In some embodiments, the plasma may be applied for a first predetermined amount of time, and the heat may be applied for a second predetermined amount of time. In some embodiments, the first predetermined amount of time may be equivalent to the second predetermined amount of time. The plasma intensity and/or heat applied may be constant and/or vary during the exposure time.

In some embodiments, the system may include a power supply 180 for powering the electrodes 130, the gas control assembly 140, the thermal control assembly 150, and/or the conveyor 160. In some embodiments, the power supply 180 may be configured such that uniform power is delivered to each electrode of the plurality of electrodes 130 such that each electrode generates the same or similar plasma characteristics. In some embodiments, the power supply 180 may include one or more power lines to control distribution of power to each of the components of the system 100. In some embodiments, the system 100 may include one or more switches for controlling distribution of power to each of the components of the system 100. In some embodiments, the power supply 180 may include one or more batteries onboard the system 100. Alternatively or additionally, the system 100 may be configured to connect to a wall plug via one or more cables. In some embodiments, the system 100 may include one or more sensors configured to monitor conditions inside the reactor 120 such that the conditions can be controlled and/or adjusted in real-time or near real-time. For example, the system 100 may implement a closed-loop feedback system in which parameters (e.g., an air composition, a temperature of the air, a temperature of the electrodes 130, a weight of the seeds, a level of infrared, a level of ultraviolet (UV), etc.) may be measured and communicated to one or more processors operatively coupled to the reactor 120. The one or more processors may be configured to adjust the feeder 110, the gas control 140, the thermal control 150, the conveyor 160, and/or the collector 170 based on the data received from the sensors.

In some embodiments, one or more characteristics of each seed may change after treatment in the reactor 120. For example, (1) morphology changes, (2) transcriptional changes, and/or (3) topology changes to the seed may occur after treatment in the reactor 120.

Morphology changes may include changes to a surface chemistry of the seed. For example, the surface of the seed may be chemically modified through conjugation of reactive oxygen and/or reactive nitrogen gas species (RONS). For example, chemical modification can occur through conjugation of nitric oxide and/or hydroxyl species. In some embodiments, super oxide ions may be conjugated on the surface of the seed. In some embodiments, a polarity of the surface of the seed may be changed.

Transcriptional changes may include changes to gene regulation due to plasma treatment such that gene expression of the seed may change after the plasma treatment. In some embodiments, the gene regulation of the seed may be altered such that a subset of genes are differentially regulated after plasma exposure.

Topology changes include changes to the structure of the seed. In some embodiments, exposure of the seeds to plasma may result in the creation of divots (e.g., dent, cavity, pit, crater, notch, indent, pit, etc.) and/or etching on the surface of the seeds. In some embodiments, the divots may have a circular (or circular-like) shape with an average diameter between about 0.1 μm and about 2 mm, inclusive of all ranges and subranges therebetween. In some embodiments, the divots may have a depth between about 0.1 μm and about 2 mm, inclusive of all ranges and subranges therebetween. In some embodiments, the etching may occur at a frequency of between about 1 divot per mm² to about 10⁶ divots per mm², inclusive of all ranges and subranges therebetween.

Additionally, a surface roughness of the seed may change after plasma treatment. The surface roughness may increase and/or decrease as a result of plasma treatment. In some embodiments, the changes in surface roughness may improve wettability of the seed. For example, the increase in surface roughness may increase wettability and decrease the contact angle. In some embodiments, the average roughness (RA) of the surface of the seed may increase with plasma exposure.

In some embodiments, a contact angle (e.g., the contact angle at which a liquid such as water creates with the surface of the seed) may decrease after plasma treatment, thereby improving wettability of the seed. Contact angle before and after plasma treatment varies with seed type, but it has been observed that in some instances, contact angle after treatment is 66% of the untreated contact angle. In some instances, contact angle after treatment is 30% or less of the untreated contact angle. In some embodiments, a roll-off angle (or a sliding angle) of liquid on the surface of the seed may change after plasma treatment.

In some embodiments, radicle length and/or a rate of emergence of the radicle may be impacted after treatment using the system 100. Radicle length represents the length of the radicle (e.g., the plant material) that is exposed through the surface of the seed. In some embodiments, the radicle length of the seed measured at a point in time may be larger for seeds that undergo plasma treatment by the system 100 than for seeds that do not undergo treatment.

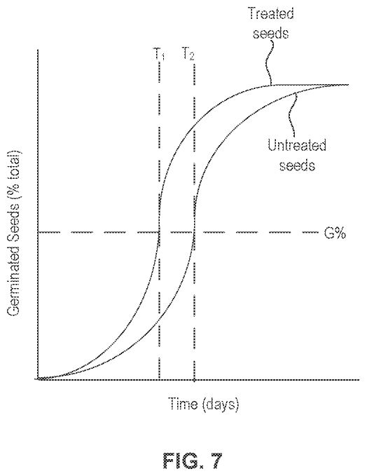

A total emergence for a batch of seeds is the number of seeds that have formed a radicle. The total emergence can be measured over time (e.g., over a period of days). The rate of emergence represents an amount of time for the radicle to emerge from the seed. In some embodiments, the average rate of emergence for a quantity of treated seeds (e.g., seeds treated using system 100) may be higher than the average rate of emergence for untreated seeds that do not undergo treatment. In other words, a percent of treated seeds that are emergent may be higher at a given time point than that of untreated seeds. FIG. 7 shows an example of how the rate of emergence of treated seeds compares to the rate of emergence of untreated seeds. As shown, at T₁, the percent of plasma treated seeds that are germinated reaches “G %”, whereas the percent of untreated seeds that are germinated is about half of that of the treated seeds. The untreated seeds do not reach “G %” of seeds germinated until T₂, which is later than T₁. In some embodiments, radicle emergence may be indicative of viability of the seed and/or plant vigor. For example, the faster a seed emerges, the more resilient to abiotic stressors (e.g., heat, drought) the seed is. Therefore, a percent of viable seeds at a given time point may be greater for seeds that undergo plasma treatment by the system 100 than for seeds that do not undergo treatment.

In some embodiments, the plasma treatment may result in at least one of the following: (1) Ablation of the seed surface physically, which removes microbes and reduce microbial load. (2) Reactive gas species, plasma, and/or heat kill deleterious pathogens on the seed surface. (3) The seed surface wetting properties (both from seed topology and surface polarity) are altered such that there is preferential growth in remaining populations and enablement of growth of probiotic species. Enablement of growth of probiotic species can generate higher yields with potentially fewer crop production inputs. (4) Metabolomic changes of the seed, due to changes to the transcriptome, prime the seed to be more resistant to pathogens and more resistant to endophytic attack from pathogens. (5) Altered wetting properties and transcriptional changes may increase vigor of seeds, which can increase yields and create uniform growth rates from seedlings, making plant management simpler. (6) Improved rate of radicle emergence and radicle length. More specifically, a higher percentage of seeds will have a longer length of the radicle (e.g., 2 mm) at a given time point. A higher rate of radicle emergence and longer radicle length are indicative of plant vigor (e.g., how quickly and big the plant will grow).

In some embodiments, the system 100 may be configured to deliver plasma treatment to a variety of species of seeds. In some embodiments, seeds that may be treated by the system 100 may include broccoli seeds, spinach seeds, cauliflower seeds, green pea seeds, lettuce seeds, corn kernels, peanuts, pumpkin seeds, flax seeds, poppy seeds, sunflower seeds, zinnia seeds, alfalfa seeds, tomato seeds, cucumber seeds, zucchini seeds, bell pepper seeds, carrot seeds, beet seeds, turnip seeds, cabbage seeds, onion seeds, celery seeds, lemongrass seeds, avocado seeds, mustard seeds, etc. In some embodiments, seeds having a range of diameters may be treated.

In some embodiments, a target pathogen may include Escherichia coli(E. coli), microflora, Listeria spp., Salmonella spp., viruses, Pseudomonas. In some embodiments, E. Coli may be the target pathogen when treating broccoli seeds. In some embodiments, microflora may be the target pathogen when treating spinach seeds. In some embodiments, the system 100 may be configured to result in at least a 0.5 log colony-forming unit (CFU) reduction of the target pathogen. Log reduction is defined by the following equation:

log reduction=log₁₀(N₀/N); wherein
N₀=CFU of the microorganisms before exposure to treatment; and
N=CFU of the microorganisms after exposure to treatment.

In some embodiments, the system 100 may be configured to result in at least a 50% reduction in disease incidence. In some embodiments, the system 100 may be configured to result in at least a 1 log reduction, at least a 2 log reduction, at least a 3 log reduction, at least a 4 log reduction, at least a 5 log reduction, at least a 6 log reduction, at least a 7 log reduction, or at least an 8 log reduction in the target pathogen.

The incumbent technology for decontamination of seeds is aqueous in nature, either hot water or a wet chemical application. In seed processing, it is well understood that if a seed is wetted, then the seed must also be dried to enable storage, and storage is needed to maintain a sellable inventory. To dry a seed requires intensive drying equipment, which utilized fossil-fuels for energy, and multiple points of human interaction to execute the process. These processes are known to impact germination, and standard industrial processes aim to only decrease standard germination by 1-2% post-treatment. The embodiments described herein can accomplish similar or better decontamination while not impacting standard germination post-treatment. Existing treatments only positively impact either germination/yield or decontamination, whereas the embodiments described herein may provide a benefit to both germination/yield and decontamination. The embodiments described herein allow for fewer points of human intervention and faster throughput. The embodiments described herein may improve usable transplants when growing seedlings, especially when growing in arid conditions or stressful environments. Additionally, the embodiments described herein may enable regrowth of microorganisms after treatment preferentially selects microbes that have positive health benefits for the seed and plant.

Chemical washes could potentially achieve scarification and/or etching of the seed surface; however, chemical washes would negatively impact germination. UV light technologies and/or steam treatment could be used to decontaminate seed surface, but these techniques would be unlikely to change germination rate and are unlikely to alter gene expression. Additionally, steam treatment may require many points of human interaction. UV light and/or hydrogen peroxide treatment could decontaminate seeds; however, this technique is unlikely to improve germination. Delivering only ozone treatment could be used for decontamination; however, this lethality to microorganisms is inferior in magnitude and rate to the embodiments described herein. Biologics and/or chemical inputs can be used to improve germination, but these techniques are unlikely to impact decontamination and will not affect scarification/etching.

In particular, qPCR testing is a rapidly growing screening technique used to attempt to verify the decontamination of seeds, for example, for international trade. qPCR, however, has a particularly high false positive rate, believed to result from a very high risk of contamination, either in sample preparation or from non-viable pathogen-associated genetic material that does not represent a true biologic risk. Embodiments described herein, which relate to treating seeds with plasma, optionally at elevated temperatures, are particularly effective at reducing qPCR screening false positives. Without wishing to be bound by theory, it is believed that stray, non-pathogenic nucleic acids are rendered undetectable because the highly oxidative nature of plasma modifies stray, non-pathogenic nucleic acids such that a qPCR probe is no longer sensitive to them and/or such that they are no longer amplified in the PCR. Embodiments described herein are particularly well suited to eliminating free nucleic acid contamination, which does not pose a biological risk, as opposed to nucleic acids contained within biological membranes (e.g., bacteria), fungi, or viable viruses. Thus, embodiments described herein are effective at reducing false positives.

Furthermore, although it is kinetically slower to modify nucleic acids within biological membranes (e.g., bacteria), fungi, or viable viruses. In some embodiments, the system 100 may also be suitable to kill and/or deactivate pathogenic microorganisms and modify their associated nucleic acids such that seeds are decontaminated, turning seed that would return a true positive on a qPCR screen into seed that does not pose a biological threat and nucleic acids associated with such pathogens modified, reducing the risk that the qPCR screen return a positive indication for biological risk.

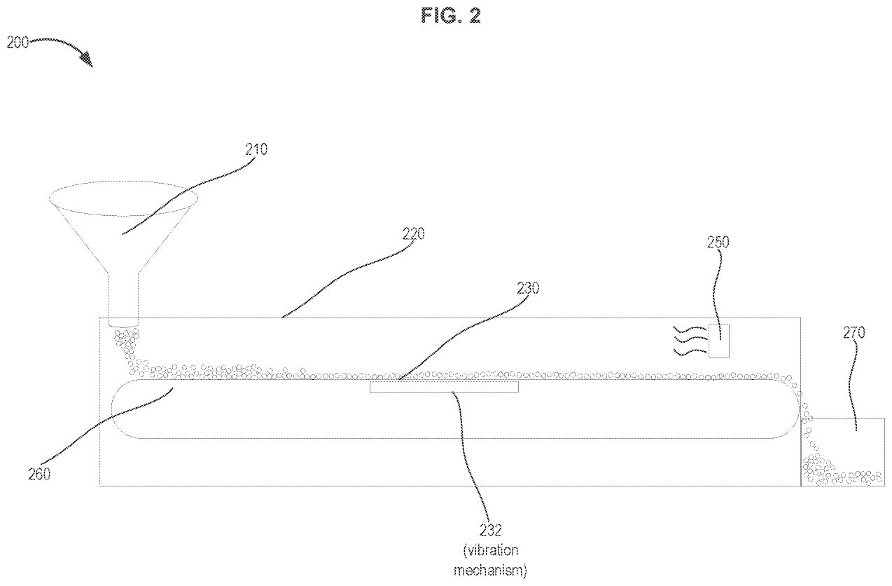

FIG. 2 is an illustration of a system 200 for plasma treatment of seeds, according to an embodiment. The system 200 may be structurally and/or functionally similar to the system 100, therefore certain details of the system 200 may not be described with respect to FIG. 2. As shown, the system 200 includes a feeder 210 configured to receive a quantity of seeds and transport the quantity of seeds onto a conveyor 260 disposed in a reactor 220. The feeder 210 includes a funnel-like structure configured to receive the quantity of seeds from a top end of the feeder 210 and deposit the seeds on the conveyor 260 from a bottom end of the feeder 210. The conveyor 260 includes a vibration mechanism 232 configured to vibrate the seeds to move the seeds across one or more electrodes 230 coupled to the conveyor 260 and toward the collector 270. The one or more electrodes 230 may be coupled to the vibration mechanism 232 of the conveyor 260 and configured to generate plasma. The vibratory mechanism 232 may be configured to shake or vibrate the one or more electrodes 230 such that an entire surface of the seeds is exposed to the plasma generated by the electrode 230. As shown, the vibratory mechanism 232 shakes or vibrates the seeds such that the seeds form a thin sheet arrangement across the one or more electrodes 230. In some embodiments, the reactor 220 further includes a thermal control assembly 250 at least partially disposed in the reactor 220. In some embodiments, the thermal control assembly 250 can control heat across the one or more electrodes 230, control heat of a surface with which the electrodes 230 contact, and/or control a temperature of the air inside the reactor 220. In some embodiments, the system 200 may optionally include a gas control assembly configured to control one or more characteristics of the air in the reactor 220. The system 200 may be configured for continuous and/or semi-continuous plasma treatment. For example, seeds may be continuously disposed in the feeder 210 and moved through the reactor 220 via the conveyor 260. In some embodiments, the vibratory mechanism 232 of the conveyor 260 may be configured to stop and start vibration in a predetermined pattern to control an exposure of the seeds to the plasma and/or heat. For example, the vibration mechanism 232 may be configured to vibrate for a first predetermined amount of time, pause for a second predetermined amount of time, and then continue vibration for the first predetermined amount of time. This cycle may be repeated until a desired quantity of seeds moves through the reactor 220 into the collector 270. In some embodiments, the plasma, the heat, and/or the vibration may be applied in a pulse pattern. In some embodiments, pulsing of the plasma, the heat, and/or the vibration may be coordinated to maximize exposure of the seed to the decontamination treatment (heat and/or plasma) and/or to ensure exposure to the decontamination treatment is uniform across the surface of the seed.

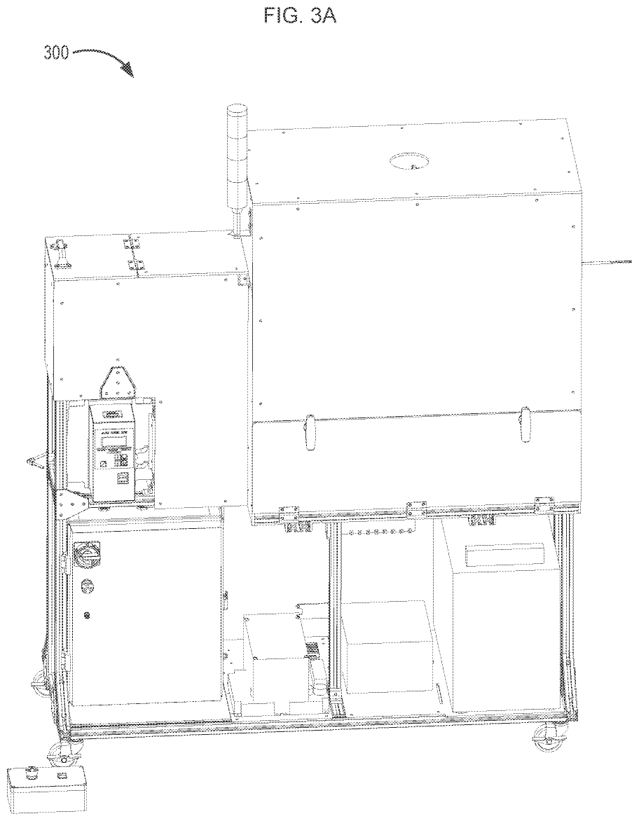

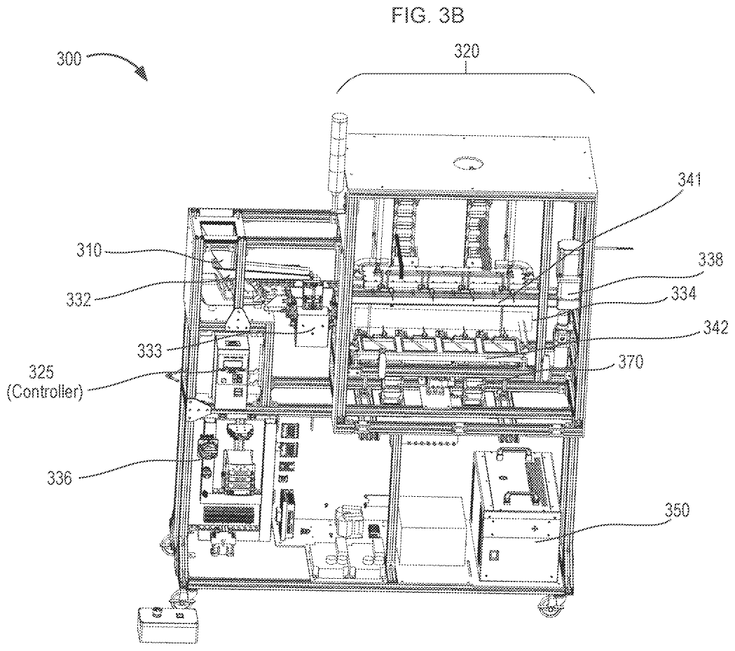

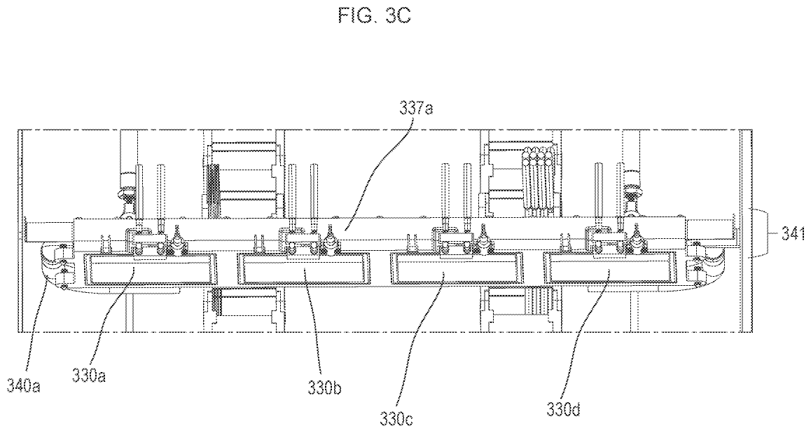

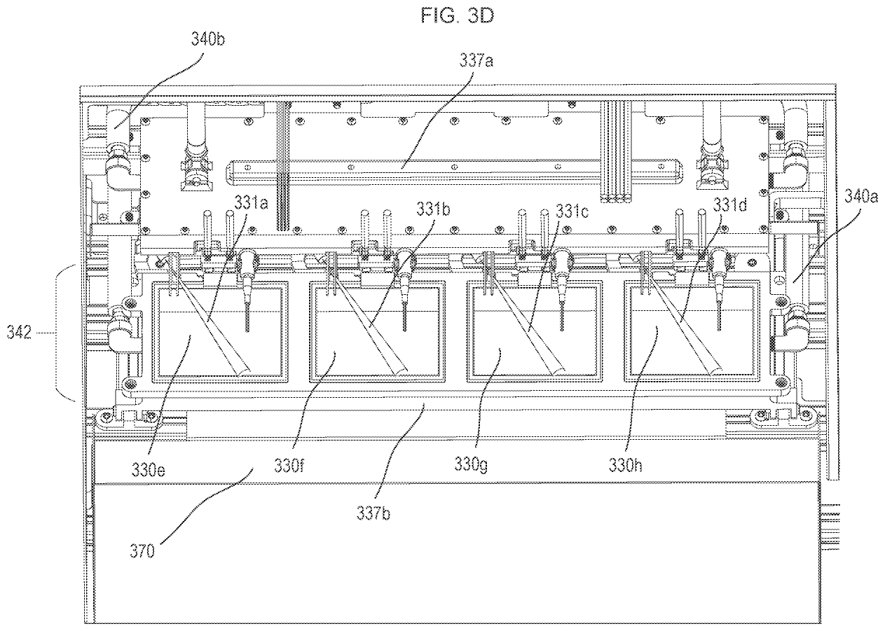

FIGS. 3A-3D are illustrations of a system 300 for plasma treatment of seeds, according to an embodiment. FIG. 3A is a front view of the system 300. The system 300 includes an enclosure in which the feeder, the reactor, and the collector are disposed. The system 300 may be used to treat seeds in batches, meaning a predetermined quantity of seeds are treated simultaneously and deposited into a collector for collection. FIG. 3B shows the system 300 with the front portion of the enclosure removed. The system 300 includes a hopper 310 resting upon a vibratory feeder 332 which is in turn powered by a controller 325. The hopper 310 is configured to receive a plurality of seeds and transport the seeds onto the vibratory feeder 332. The vibratory feeder 332 is configured to vibrate or shake to move the plurality of seeds toward a distribution mechanism including a gantry hopper 333. In some embodiments, the vibratory feeder 332 may be configured to move the seeds into the gantry hopper 333 at a predetermined rate. The gantry hopper 333 may be filled via the vibratory feeder 332 to a predetermined weight, wherein the weight is controlled via closed-loop feedback. In some embodiments, the gantry hopper 333 may include one or more sensors configured to measure the weight of the plurality of seeds disposed therein. In some embodiments, seeds may be prevented from moving into the gantry hopper 333 after the predetermined weight is reached.

In some embodiments, the distribution mechanism may further include an actuator (e.g., a motor such as a stepper motor) 338. The stepper motor 338 may actuate the gantry hopper 333 left and right to convey and deposit untreated seeds sequentially into a plurality of defined areas within a treatment zone 334 (e.g., on the electrodes). For example, in some instances, the gantry hopper 333 can deposit 5-20 g of seeds per electrode. The treatment zone 334 is defined by a position of an upper treatment bed 341 and a lower treatment bed 342. In some embodiments, the upper treatment bed 341 may include a first set of electrodes, and the lower treatment bed 342 may include a second set of electrodes. The upper treatment bed 341 and the lower treatment bed 342 may start in a starting position in which the upper treatment bed 341 is positioned at a first distance from the lower treatment bed 342. In some embodiments, the distribution mechanism may be configured to drop or place a predetermined quantity of seeds onto each electrode. In some embodiments, the predetermined quantity of seeds may be evenly distributed across the first set of electrodes in a layer having a predetermined depth (e.g., a monolayer, a bilayer, a tri-layer, etc.), then the gantry hopper 333 may move to the next electrode and repeat the process. After the seeds are deposited in the treatment zone 334, the treatment beds 341, 342 transition to a treatment configuration in which the upper treatment bed 341 descends toward the lower treatment bed 342 to a second distance from the lower treatment bed 342. In some embodiments, the second distance between the upper treatment bed 341 and the lower treatment bed 342 when the treatment beds 341, 342 are in the treatment configuration may correspond to a diameter of the seed being treated. Similarly stated, the treatment beds 341, 342, may be closer together for small seeds and further apart for large seeds. In some instances, the treatment beds 341, 342 can be no further apart than twice the mean diameter of the seed being treated in the treatment configuration. In other instances, the treatment beds 341, 342 can be spaced apart at a greater distance such as, for example, six times mean seed diameter. In some embodiments, the lower treatment bed 342 may be configured to agitate or mix the seeds during treatment to aid in uniform exposure of the seeds to the plasma and/or reactive gas species. The system may further include a thermal control assembly 350 configured to control heat across the electrodes and a gas control assembly configured to control the gas inside the reactor 320 (such as the gas in the treatment zone 334).

In some embodiments, the system 300 including the upper treatment bed 341 and the lower treatment bed 342 may provide more even distribution of plasma to the seeds. Upon completion of the prescribed treatment, the upper treatment bed 341 may retract to the starting position and the lower treatment bed 342 may rotate into an angled position (e.g., a vertical position), such that the treated seeds are rolled into a collection hopper 370. The described steps may then be repeated. The system 300 may include a rotary lockout switch 336 configured to control distribution of line power to the entire system 300.

FIG. 3C shows a side view of the upper treatment bed 341. The upper treatment bed 341 includes a first electrode assembly 330a, a second electrode assembly 330b, a third electrode assembly 330c, and a fourth electrode assembly 330d and an upper plate cover 337a configured to cover a top surface of each electrode assembly 330a-330d. Proximate to the upper treatment bed 341 is a first gas input/output tube 340a and a second gas input/output tube 340b. The gas input/output tubes 340a, 340b are configured to deliver and or remove gas from the treatment zone. FIG. 3D shows an overhead view of the lower treatment bed 342 including a fifth electrode assembly 330e, a sixth electrode assembly 330f, a seventh electrode assembly 330g, an eighth electrode assembly 330h. Each of the electrode assemblies 330e-330h are configured to align with the electrode assemblies 330a-330d. Each of the electrode assemblies 330e-330h are coupled to an infrared sensor 331a, 331b, 331c, 331d configured to measure temperature and/or heat level at or near the surface of the electrode assemblies 330e-h. In some embodiments, each electrode assembly 330e-330h may be coupled to a high voltage wire and a low voltage wire. The collection hopper 370 is arranged proximate to the lower treatment bed 342 such that the seeds can be moved into the collection hopper 370 after treatment of the seeds.

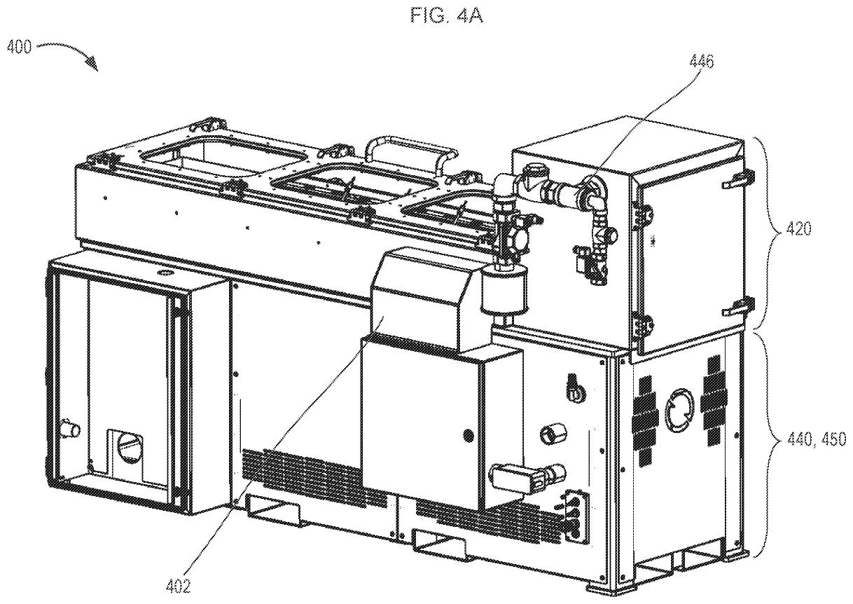

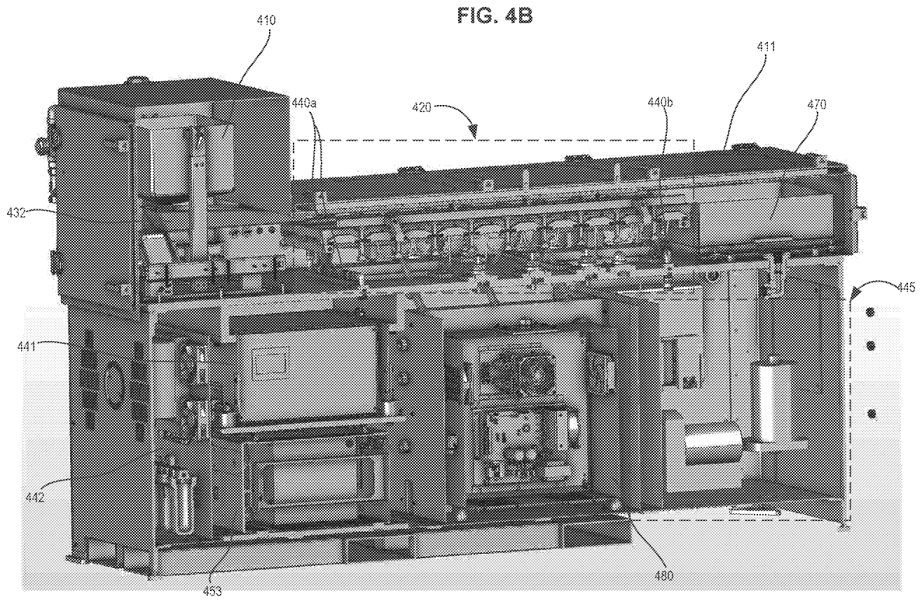

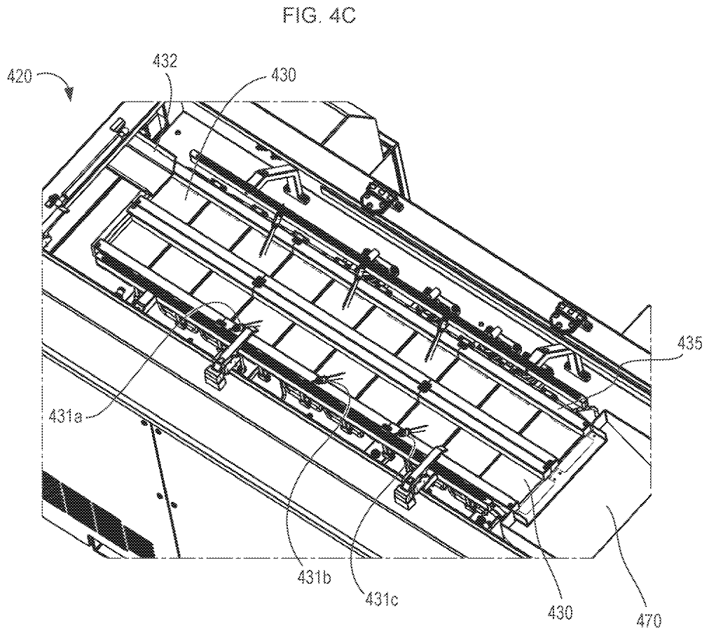

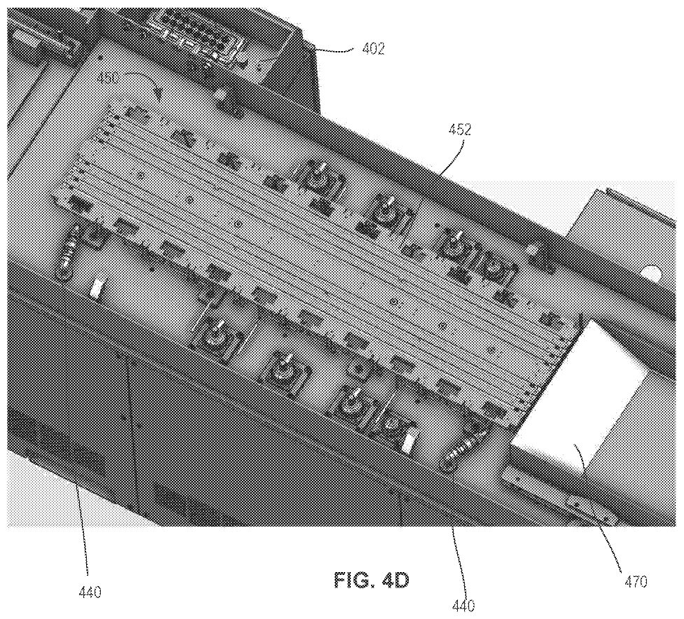

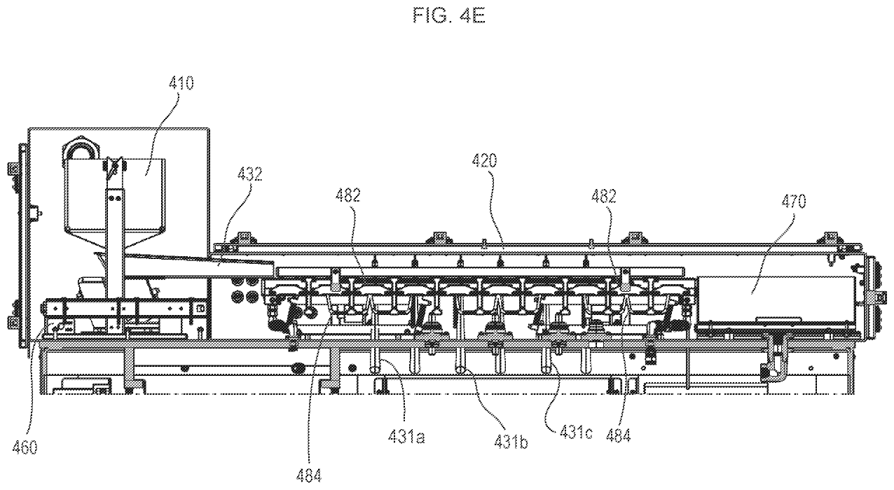

FIGS. 4A-4E are illustrations of a system 400 for plasma treatment of seeds, according to an embodiment. FIG. 4A is an isometric view of a back side of a system 400 for plasma treatment of seeds, according to an embodiment. A gas control assembly 440, power control, and a thermal control assembly 450 may be located in a bottom portion of the system 400, and the plasma treatment may occur in a top portion of the system 400 which contains a reactor 420. Therefore, the system 400 may provide fine-tuned gas control. The system 400 may include housing 402 which houses electronic circuitry to control the system 400. For example, the electronic circuitry may include a programmable logic controller (PLC). The electronic circuitry may include one or more processors (e.g., a central processing unit (CPU)) configured to receive data from one or more sensors in the system 400. The system 400 may include, for example, temperature sensors, humidity sensors, gas concentration sensors (e.g., ozone detector), light sensors (e.g., infrared sensors and/or UV sensors), optical sensors, vibrational sensors, etc. configured to send data to the one or more processors such that the one or more processors can control parameters during treatment of the seeds. As such, system 400 may implement a closed-loop feedback system for controlling the environment inside the reactor 420 during treatment of the seeds. In some embodiments, control of the system may be local via the electronic circuitry in housing 402. In some embodiments, the electronic circuitry may be configured to connect to an external device for remote control of the system 400.

The intake gas may flow into the reactor 420 via one or more gas input/output tubes (e.g., pipes) 446. In some embodiments, the gas input/output tubes 446 may place an inner volume of the reactor 420 in fluid communication with the air handler 441. In some embodiments, the gas input/output tube 446 may place the inner volume of the reactor 420 in fluid communication with the gas blower assembly 445. In some embodiments, a flow direction of the gas may be controlled via valves in the input/output tubes 446. In some embodiments, the valves may be controlled by the PLC and/or one or more processors in the housing 402. As such, the PLC and/or one or more processors may control flow of gas (e.g., flow rate, composition, direction, etc.) into and/or out of the reactor 420. FIG. 4B shows a cross-section of a front view of the system 400. As shown, the system 400 includes a hopper 410 and a vibratory feeder 432 configured to continuously or semi-continuously deposit the seeds into the reactor 420. The seeds may move through the reactor 420 from the vibrating feeder 432 to the collector 470. Below the reactor 420, the system 400 includes an air handler 441 (e.g., including a humidifier and/or a dehumidifier) configured to control humidity of the intake gas. The air handler 441 and the is coupled to a venting system 442. A plasma power box 480 is configured to deliver power to the electrodes. The system 400 may further include a gas blower assembly 445 configured to control and/or monitor a composition of the intake gas (e.g., concentration of ozone) and to control a flow rate of the intake gas into the reactor 420. The gas blower assembly 445 may include an ozone detector (not shown) and a UV detector 447 configured to measure and/or monitor the concentration of ozone and an amount of UV light, respectively. The system 400 may include a thermal control system 453 configured to control temperature of the electrodes by controlling temperature of a plate on which the electrodes are disposed (e.g., an electrode bed) and/or the coolant in contact with the electrode bed. The thermal control system 453 may heat and cool the coolant to maintain the temperature of the plasma reactor surface within a predetermined range. Thermal control lines 440a and 440b connect the reactor 420 to the thermal control system 453. The system 400 may include an access door 411 such that a user can access the reactor 420 to input seeds into the hopper 410, to remove seeds from the collector 470, and/or for maintenance, for example.

FIG. 4C shows an overhead view of the reactor 420 with the access door 411 removed. The reactor 420 includes a plurality of electrode assemblies 430 arranged to create a path between the vibratory feeder 432 and the collector 470 on which the plurality of seeds may be treated. The plurality of electrode assemblies 430 may be arranged in two rows with guard rails 435 disposed on either side of each row of electrode assemblies 430. One or more infrared sensors 431a, 431b, 431c may be disposed proximate to the electrode assemblies 430 and configured to measure infrared (e.g., temperature) at or near the surface of the electrode assemblies 430.

It has been observed that the density of seed packing and depth of seeds on the electrode assemblies 430 are, in some instances, critical parameters to the effectiveness of seed treatment. Without wishing to be bound by theory, it is believed that this is the result of decreasing heat transfer efficiency and/or decreasing reactive gas species permeability as seed bed depth increases and packing density increases. In any event, it has been observed that treatment efficiency is surprisingly sensitive to bed height and/or bed density. For example, for averaged sized seeds (e.g., peppers) seed treatment effectiveness decreases when the depth of seeds on the electrode assemblies 430 exceed 3.3 mm. Seed treatment effectiveness may drop off when the depth of the layer is lower (e.g. 1.5 mm or lower) for small seeds, such as celery. Surprisingly, it has been observed that the electrode assembly can 430 can be more than 100% full. It had previously been suspected that a monolayer and/or a sparse layer of seeds would achieve optimal performance by allowing for maximum exposure to reactive gas species. Similarly stated, in some embodiments, it has been observed that a relatively thick layer of seeds can be achieved without significant decrease in performance. Without wishing to be bound by theory, this is believed to be achievable due to relatively high heat transfer through a seed bed, including heat transfer rates that are not realistically achievable without generating a plasma at the relevant volumes and durations.

Accordingly, throughput in the reactor 420 can be determined by maximizing the bed depth at which treatment remains effective. This bed depth can be multiplied by the surface area of the electrode assembly to determine a treatment volume. Volumetric flow rate can be calculated by dividing by dwell time, which can be the amount of time to effectively decontaminate seeds, without negatively affecting germination, which can be empirically determined.

FIG. 4D shows part of the thermal control assembly 450 underneath the electrode assemblies 430. The electrode bed (or cooling plate) 452 may be disposed under the electrodes 430. The electrode bed 452 may be coupled to a plurality of tubes or channels through which coolant may flow. Heat from the electrodes 430 may be dissipated into the cooling plate 452. In some embodiments, the heat may then be dissipated into the coolant in the tubes. As coolant moves through the tubes and exits the reactor 220, the heat dissipated from the electrodes 430 is also removed from the reactor 420. Conversely, in some implementations, heat may be added to the electrodes 430 via the thermal control assembly 450 to keep the electrodes above a threshold critical temperature to enable consistent plasma uniformity (e.g., above 95 degrees F to prevent condensation on the electrodes which inhibits plasma firing).

FIG. 4E shows a side view of the system 400 showing the feeder 410, the reactor 420, and the collector 470. A conveyor may be coupled to the vibratory feeder 432 and/or the electrodes 430 and configured to move the seeds from the feeder 410 to the collector 470. In some embodiments, the conveyor may be configured to continuously vibrate to move the seeds through the reactor 420. In some embodiments, the conveyor may be configured to pulse vibration such that the seeds may alternate between moving and being stationary during plasma treatment. In particular, because activation of the electrode bed 452 can cause seeds to adhere and become difficult to transport due to static electricity, in some embodiments, the electrode bed 452 can be cycled on and off and the conveyor can be operable to vibrate when the electrode bed 452 is deenergized. In some embodiments, each electrode assembly 430 may be connected to a high voltage wire 482 and a low voltage wire 484 configured to transfer electrical signals from the plasma power control box 480 to the electrodes 430. In some embodiments, the system 400 may include an additional power supply and power supply control.

FIG. 5 is an illustration of an electrode assembly 530 used in the system for delivering plasma treatment to seeds, according to an embodiment. As shown, the electrode assembly 530 includes a first electrode 543 (e.g., a high voltage electrode) and a second electrode 535 (e.g., a ground electrode) with a dielectric 539 disposed therebetween. Plasma is generated near a top surface of the first electrode 543. The electrodes 535, 543 are connected to a voltage and/or current source. In some embodiments, the voltage and/or current source may include an alternating current and/or a direct current source. In some embodiments, the electrodes 535, 543 may include a material including platinum, gold, carbon, aluminum, stainless steel, graphite, tungsten, silver, copper, or a suitable combination thereof. In some embodiments, the electrodes 535, 543 include aluminum. In some embodiments, the first electrode 543 and the second electrode 535 may be formed from the same material. In some embodiments, the first electrode 543 may have a first thickness, and the second electrode 535 may have a second thickness, the first thickness being greater than the second thickness. In some embodiments, the dielectric 539 may include a ceramic, a metal, a mica, glass, quartz, borosilicate, and/or a plastic. In some embodiments, the dielectric 539 may include a material including alumina (e.g., aluminum oxide). In some embodiments, the dielectric 539 may be grooved. In some embodiments, the dielectric 539 may include one or more curved or tubular shapes. In some embodiments, the first electrode 543 and/or the second electrode 535 may be embedded within the dielectric 539. As shown, the dielectric 539 has a thickness t. The thickness t may be in a range of about 25 μm to about 2 mm, inclusive of all ranges and subranges therebetween.

The system may have any suitable number of electrodes. Typically, the number of electrodes is constrained by available power. The power supply and/or transformers powering the electrodes can be operable to dynamically balance the frequency, which provides uniform plasma generation across the electrode array and limits cell-to-cell arcing. Some embodiments include 5-24 electrodes. Each electrode has a limited size. Accordingly, seed throughput can be set to achieve a predetermined treatment time within the reactor, given the collective surface area of the electrode array. In some implementations, it may be important that the power supply be capable of dynamically balancing the frequency between cells to reduce cell-to-cell arcing. Thus, in some implementations, the power supply's ability to dynamically balance power may constrain the number of electrodes.

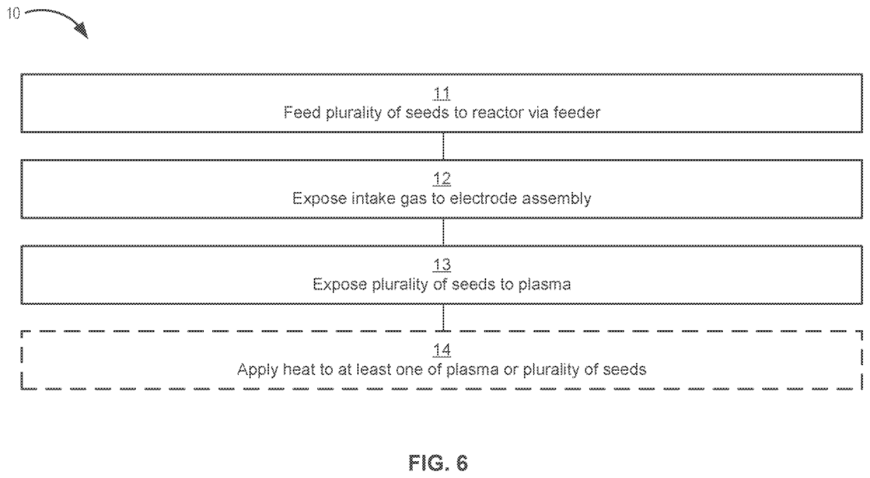

FIG. 6 is a flow diagram of a method 10 of plasma treatment of seeds, according to an embodiment. While described with respect to system 100 having a reactor 120 including a feeder 110, electrode 130, gas control 140, thermal control 150, a conveyor 160, and a collector 170, it should be appreciated that the method is equally applicable to any system having a reactor including a feeder, electrode, gas control, thermal control, conveyor, and collector, and/or any other components described herein. All such variants should be considered to be within the scope of this disclosure.

In some embodiments, the method 10 includes feeding a plurality of seeds to a reactor 120 via a feeder 110, at 11. In some embodiments, a user may feed the plurality of seeds to the feeder 110. In some embodiments, the feeder 110 may be configured to transfer a predetermined quantity of seeds into the reactor 120. The feeder 110 may be configured to transfer the seeds such that the seeds at least partially form a monolayer. At 12, the method 10 includes exposing an intake gas to the electrode assembly. In some embodiments, a temperature, a pressure, composition, and/or the relative humidity of the intake gas may be adjusted before exposing the intake gas to the electrode assembly. In some embodiments, the relative humidity of the intake gas may be no more than 35%. In some embodiments, the intake gas may include conditioned air. In some embodiments, the intake gas may include additional gases and/or chemicals (e.g., noble gases, ozone, and/or nitrous oxide). In some embodiments, the intake gas may be configured to improve the effectiveness of the plasma generated by the electrode assembly. For example, the intake gas may be configured to increase a concentration of reactive gas species, thereby increasing effectiveness of decontamination and the likelihood the seeds undergo a change in composition that benefits germination.

The method 10 includes exposing a plurality of seeds to plasma, at 13. In some embodiments, at least one of a pulse frequency, a pulse width, a temperature, or a composition of the plasma may be controlled. In some embodiments, the seeds may be directly exposed to cold plasma. In some embodiments, the pulse frequency may be in a range of 10 khz to 20 khz, inclusive of all ranges and subranges therebetween. In some embodiments, the pulse width of the plasma pulses may be at least about 25%. In some embodiments, the plasma may include at least one of ozone, nitrous oxide, and/or hydrogen peroxide. In some embodiments, the voltage applied across the electrodes 130 may be in a range of about 1.7 kV to about 10 kV to generate the desired plasma field.

In some embodiments, the method 10 optionally includes applying heat to at least one of the plasma or the plurality of seeds, at 14. In some embodiments, the heat may be operable to decontaminate the seeds. In some embodiments, the heat may be applied in combination with the plasma. In some embodiments, the heat may kill one or more pathogens at a surface of the seed. In some embodiments, a combination of the plasma and the heat may enable better decontamination of the seeds than just plasma exposure. In some embodiments, the heat may be applied through the electrodes 130, and the heat may be controlled by controlling a voltage across the electrodes. In some embodiments, the temperature may be controlled by controlling a plate with which the electrodes are in contact with and/or on which the electrodes are disposed (e.g., the electrode bed or cooling plate). In some embodiments, the surface temperature of the electrodes may be in a range of about 25 °C to about 105 °C. In some embodiments, the heat may be controlled by controlling the temperature of the air in the reactor 120. In some embodiments, the method may further include collecting the treated seeds from the collector 170. In some embodiments, the method may be repeated any number of times until a desired quantity of seeds is treated. In some embodiments, steps 12-14 may be completed by the system 100 without manual intervention.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embody such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

1. A system, comprising:
a reactor vessel configured to receive a plurality of seeds;
a gas supply in fluid communication with the reactor vessel and configured to deliver a gas to the reactor vessel;
an electrode assembly, the electrode assembly configured to receive at least one of a supply of current or the gas and to produce plasma;
a conveyor configured to transport the plurality of seeds through the reactor vessel; and
a power supply configured to power at least one of: the electrode assembly or the conveyor.

2. The system of claim 1, wherein the electrode assembly includes a high-voltage electrode, a ground electrode, and a dielectric plate.

3. The system of claim 2, wherein the dielectric plate includes at least one of alumina, ceramic, mica, glass, quartz, borosilicate, or a plastic.

4. The system of claim 1, further comprising at least one of:
a vibration device configured to vibrate the plurality of seeds into a thin sheet arrangement, the thin sheet arrangement having a thickness below a threshold; or
a thermal control device operably couplable to the reactor vessel, the thermal control device configured to heat the electrode assembly to at least a temperature threshold.

5. The system of claim 4, wherein the thickness threshold is no more than about 3.3 millimeters.

6. The system of claim 4, wherein the temperature threshold of the electrode assembly is at least about 95 degrees Fahrenheit.

7. The system of claim 1, wherein the gas includes at least one of: ozone (O₃), oxygen (O₂), carbon dioxide (CO₂), nitrogen (N₂), noble gases (e.g., helium (He), neon (Ne), argon (Ar), krypton (Kr), xenon (Xe).

8. The system of claim 1, wherein the electrode assembly includes a plurality of high-voltage electrodes.

9. The system of claim 1, wherein the electrode assembly includes a plurality of high-voltage electrodes arranged in a hexagonal pattern.

10. The system of claim 1, further comprising:
a feeder configured to deliver a plurality of seeds to the reactor vessel.

11. The system of claim 1, wherein at least one of the reactor vessel, the gas supply, the electrode assembly, the conveyor, a thermal control device, a collector, or the power supply includes one or more sensors configured to monitor one or more parameters thereof.

12. The system of claim 11, further comprising:
a controller communicably couplable to the one or more sensors, the controller configured to:
receive a signal from the one or more sensors, the signal indicative of a parameter of the at least one of the reactor vessel, the gas supply, a thermal control device, the electrode assembly, the conveyor, a collector, or the power supply, and
alter one or more parameters thereof based on the received signal.

13. A method, comprising:
transferring a plurality of seeds to a reactor;
transferring a gas to an electrode assembly, the electrode assembly including a ground electrode, a high-voltage electrode, and a dielectric, thereby forming a plasma;
exposing the plurality of seeds to the plasma for a first time period; and
applying heat to at least one of the plurality of seeds or the plasma for a second time period.

14. The method of claim 13, wherein the gas includes ambient air.

15. The method of claim 13, wherein the gas includes conditioned air.

16. The method of claim 15, wherein the conditioned air has a relative humidity of less than about 30%.

17. The method of claim 13, wherein the gas includes at least one of: ozone (O₃), oxygen (O₂), carbon dioxide (CO₂), nitrogen (N₂), noble gases (e.g., helium (He), neon (Ne), argon (Ar), krypton (Kr), xenon (Xe).

18. The method of claim 13, further comprising:
chemically treating the gas to alter a parameter of the gas, wherein the chemical used to treat the gas includes at least one of hydrogen peroxide (H₂O₂), nitric acid (HNO₃), peracetic acid (C₂H₄O₃), or acetic acid (CH₃COOH).

19. The method of claim 13, wherein a voltage applied between the ground electrode and the high-voltage electrode is between about 2 kV and about 4 kV.

20. The method of claim 13, wherein the first time period is equal to the second time period.
